(19) United States
(12) Patent Application Publication
(10) Pub. No.: US 2017/0344177 A1
(43) Pub. Date: Nov. 30, 2017

(54) METHOD AND DEVICE FOR DETERMINING OPERATION MODE OF TERMINAL

(71) Applicant: Beijing Xiaomi Mobile Software Co., Ltd., Beijing (CN)

(72) Inventors: Ming WU, Beijing (CN); Hengbin Cui, Beijing (CN); Qianqian Wang, Beijing (CN)

(73) Assignee: Beijing Xiaomi Mobile Software Co., Ltd.

(21) Appl. No.: 15/602,330

(22) Filed: May 23, 2017

(30) Foreign Application Priority Data
May 24, 2016 (CN) 201610350467.8

(51) Int. Cl. G06F 3/041

(52) U.S. Cl. CPC G06F 3/0416

(57) ABSTRACT

A method for determining an operation mode of a terminal, includes: receiving an instruction for switching to a one-handed operation mode; acquiring touch information of a user on a touch edge of the terminal; and controlling the terminal to enter a corresponding one of one-handed operation modes according to the touch information, wherein the one-handed operation modes include a first operation mode and a second operation mode.

### CROSS-REFERENCE TO RELATED APPLICATIONS

The present application is based upon and claims priority to Chinese Patent Application No. 201610350467.8, filed May 24, 2016, the entire contents of which are incorporated herein by reference.

### TECHNICAL FIELD

The present disclosure generally relates to the field of terminals, and more particularly, to a method and device for determining an operation mode of a terminal.

### BACKGROUND

With the emergence of mobile phones having a large screen, one-handed mode has become available in order to facilitate user operation. If a user wants to enter the one-handed mode, settings need to be performed manually, and user operation is relatively complicated, which degrades user experience.

### SUMMARY

According to a first aspect of the present disclosure, there is provided a method for determining an operation mode of a terminal, comprising: receiving an instruction for switching to a one-handed operation mode; acquiring touch information of a user on a touch edge of the terminal; and controlling the terminal to enter a corresponding one of one-handed operation modes according to the touch information, wherein the one-handed operation modes include a first operation mode and a second operation mode.

According to a second aspect of the present disclosure, there is provided a terminal, comprising: a processor; and a memory for storing instructions executable by the processor; wherein the processor is configured to: receive an instruction for switching to a one-handed operation mode; acquire touch information of a user on a touch edge of the terminal; and control the terminal to enter a corresponding one of one-handed operation modes according to the touch information, wherein the one-handed operation modes include a first operation mode and a second operation mode.

According to a third aspect of the present disclosure, there is provided a non-transitory readable storage medium having stored therein instructions that, when executed by a processor of a terminal, cause the terminal to perform a method for determining an operation mode of the terminal, the method comprising: receiving an instruction for switching to a one-handed operation mode; acquiring touch information of a user on a touch edge of the terminal; and controlling the terminal to enter a corresponding one of one-handed operation modes according to the touch information, wherein the one-handed operation modes include a first operation mode and a second operation mode.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for determining an operation mode of a terminal according to an exemplary embodiment.

FIG. 2 is a flow chart of a method for determining an operation mode of a terminal according to an exemplary embodiment.

FIG. 3 is a flow chart of a method for determining an operation mode of a terminal according to an exemplary embodiment.

FIG. 4 is a schematic diagram illustratively showing touch points according to an exemplary embodiment.

FIG. 5 is a schematic diagram illustratively showing touch points according to an exemplary embodiment.

FIG. 6 is a flow chart of a method for determining an operation mode of a terminal according to an exemplary embodiment.

FIG. 7 is a further schematic diagram illustratively showing one or more touch points according to an exemplary embodiment.

FIG. 8 is a flow chart of a method for determining an operation mode of a terminal according to an exemplary embodiment.

FIG. 9 is a block diagram of a device for determining an operation mode of a terminal according to an exemplary embodiment.

FIG. 10 is a block diagram of an acquisition module in a device for determining an operation mode of a terminal according to an exemplary embodiment.

FIG. 11 is a block diagram of a control module in a device for determining an operation mode of a terminal according to an exemplary embodiment.

FIG. 12 is a block diagram of an acquisition module in a device for determining an operation mode of a terminal according to an exemplary embodiment.

FIG. 13 is a block diagram of a control module in a device for determining an operation mode of a terminal according to an exemplary embodiment.

FIG. 14 is a block diagram of a device for determining an operation mode of a terminal according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

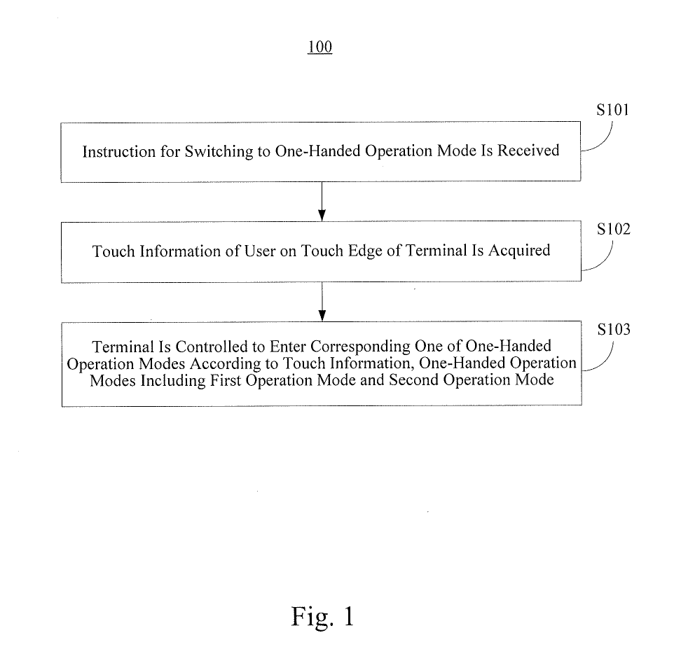

FIG. 1 is a flow chart of a method 100 for determining an operation mode of a terminal. For example, the method 100 may be applied in a terminal. As shown in FIG. 1, the method 100 includes steps S101-S103.

In step S101, an instruction for switching to a one-handed operation mode is received.

For example, when using one hand to operate the terminal, a user can input an instruction for switching to the one-handed operation mode, so that the terminal can enter the one-handed operation mode, which is convenient for the user to operate the terminal.

In step S102, touch information of a user on a touch edge of the terminal is acquired.

For example, the touch edge enables an operable region of the terminal to extend from a screen to one or more sides of a frame of the terminal. The touch edge can be the frame formed by metal or plastic materials, or the like, and a touch region is set within the frame to receive touch operations of the user. Also for example, a touch screen can have no frame, and the whole touch screen is formed by glass without physical buttons, and all sides of the touch screen can be touched and operate as the touch edge.

In step S103, the terminal is controlled to enter a corresponding one of one-handed operation modes according to the touch information, the one-handed operation modes including a first operation mode and a second operation mode.

In the exemplary embodiment, when the instruction for switching to the one-handed operation mode is received, the terminal acquires the touch information of the user on the touch edge of the terminal, and the terminal is controlled to enter the corresponding one-handed operation mode (such as a left-handed operation mode or a right-handed operation mode) according to the touch information. Thus, it is convenient for user operation, and user experience is improved.

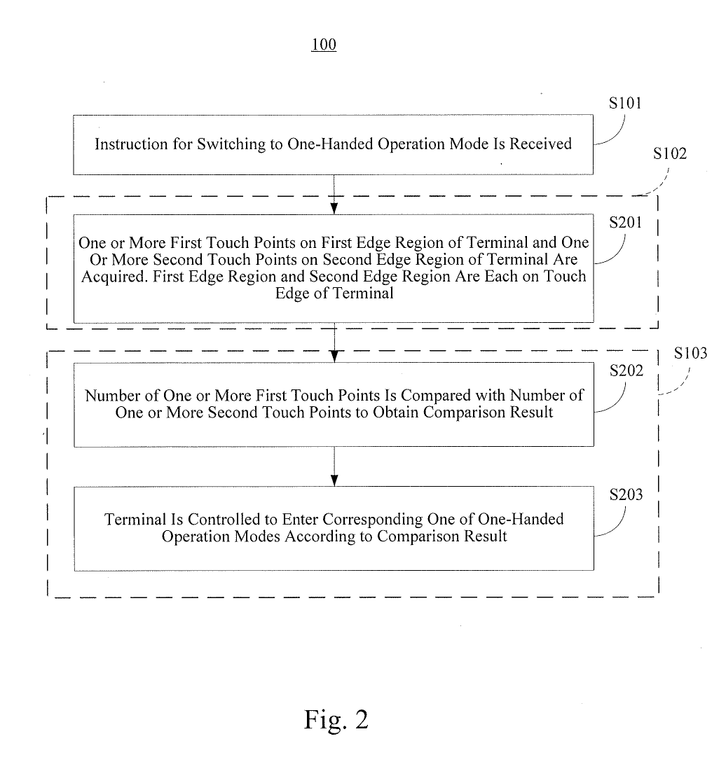

In one exemplary embodiment, shown in FIG. 2, step S102 includes steps S201. In step S201, one or more first touch points on a first edge region of the terminal and one or more second touch points on a second edge region of the terminal are acquired. The first edge region and the second edge region are each on a touch edge of the terminal.

The touch edge of the terminal can be divided into the first and second edge regions, the first edge region can be the left edge region, and the second edge region can be the right edge region. When the user holds the terminal, the user's fingers of the user will contact the first and second edge regions, and one or more touch points will be formed on the first and second edge regions.

Accordingly, as shown in FIG. 2, step S103 includes steps S202 and S203.

In step S202, a number of the one or more first touch points is compared with a number of the one or more second touch points to obtain a comparison result.

In step S203, the terminal is controlled to enter the corresponding one of the one-handed operation modes according to the comparison result.

In the exemplary embodiment, when the user uses different hands to hold the terminal, the number of the one or more first touch points on the first touch region and the number of the one or more second touch points on the second touch region are different. Therefore, by comparing the number of the one or more first touch points with the number of the one or more second touch points, the terminal can be controlled to enter the left-handed mode or the right-handed mode. Thus, it is convenient for the user to use a left hand or a right hand to perform the one-handed operation, and user experience is improved.

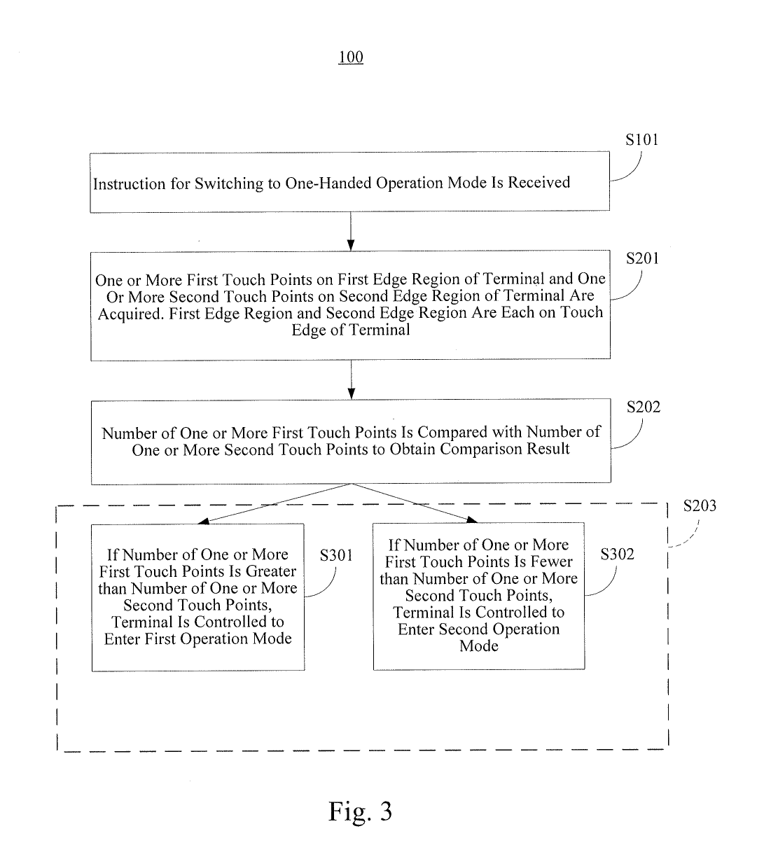

In one exemplary embodiment, shown in FIG. 3, step S203 includes steps S301 and S302.

In step S301, if the number of the one or more first touch points is greater than the number of the one or more second touch points, the terminal is controlled to enter the first operation mode.

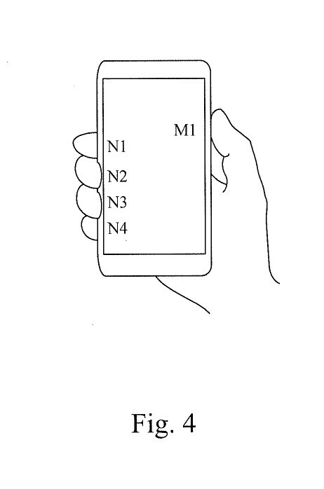

FIG. 4 is a schematic diagram illustratively showing touch points according to an exemplary embodiment. As shown in FIG. 4, each first touch point is represented with “N”, and each second touch point is represented with “M”. In FIG. 4, there are four first touch points, i.e., N1, N2, N3 and N4, and the total number of the first touch points is 4. There is one second touch point, i.e., M1, and the total number of the second touch points is 1. It can be seen that the number of the first touch points is greater than the number of the second touch point, and the terminal is controlled to enter the first operation mode. The first operation mode may be the right-handed operation mode, for example.

Referring back to FIG. 3, in step S302, if the number of the one or more first touch points is fewer than the number of the one or more second touch points, the terminal is controlled to enter the second operation mode.

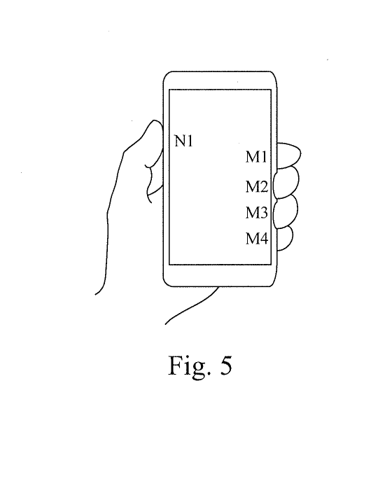

FIG. 5 is a schematic diagram illustratively showing touch points according to an exemplary embodiment. As shown in FIG. 5, similarly, each first touch point is represented with “N”, and each second touch point is represented with “M”. In FIG. 5, there is one first touch point, i.e., N1, and the total number of the first touch point is 1. There are four second touch points, i.e., M1, M2, M3 and M4, and the total number of the second touch points is 4. It can be seen that the number of the first touch point is fewer than the number of the second touch points, and the terminal is controlled to enter the second operation mode. The second operation mode may be the left-handed operation mode, for example.

In this way, the corresponding one-handed operation mode is entered according to a holding manner of the terminal by the user without manually setting the one-handed operation mode. Thus, user operation is reduced, and user experience is improved.

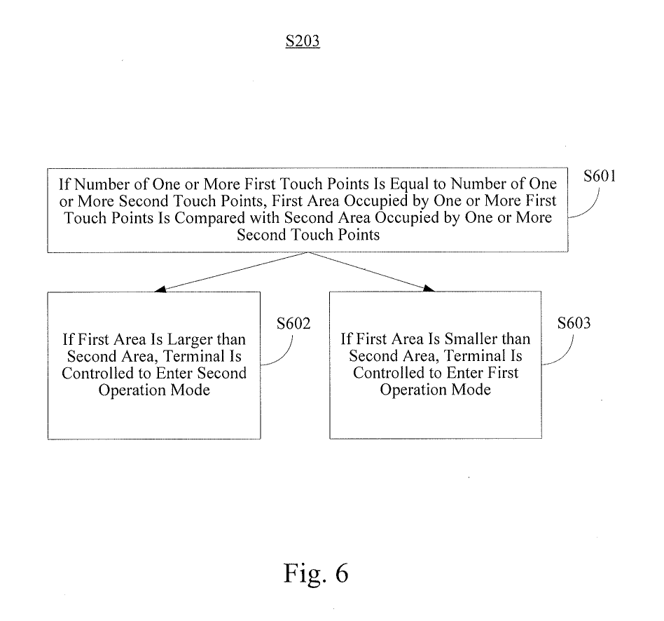

In one exemplary embodiment, shown in FIG. 6, step S203 (FIG. 2) further includes steps S601-S603.

In step S601, if the number of the one or more first touch points is equal to the number of the one or more second touch points, a first area occupied by the one or more first touch points is compared with a second area occupied by the one or more second touch points.

In step S602, if the first area is larger than the second area, the terminal is controlled to enter the second operation mode.

In step S603, if the first area is smaller than the second area, the terminal is controlled to enter the first operation mode.

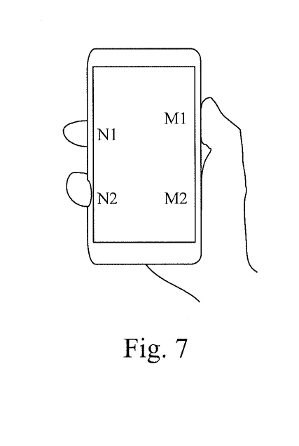

In the exemplary embodiment, a situation that touch points on two touch regions are the same may also appear. As shown in FIG. 7, the number of the first touch points and the number of the second touch points are both 2. Since an area of second touch points M1 and M2 formed by a thumb and a palm is larger than an area of first touch points N1 and N2 formed by other fingers, whether the terminal is held by the left hand or the right hand of the user at this time can be distinguished by an area occupied by the touch points. If the first area occupied by the first touch points N1 and N2 is greater than the second area occupied by the second touch points M1 and M2, it indicates that the user uses the left hand to hold the terminal, and thus the second operation mode (i.e., the left-handed operation mode in the exemplary embodiment) may be entered. If the first area occupied by the first touch points N1 and N2 is smaller than the second area occupied by the second touch points M1 and M2, it indicates that the user uses the right hand to hold the terminal, and thus the first operation mode (i.e., the right-handed operation mode in the exemplary embodiment) may be entered. In this way, the corresponding one-handed operation mode is entered according to a holding manner of the terminal by the user without manually setting the one-handed operation mode. Thus, user operation is reduced, and user experience is improved.

In the above embodiments, the terminal enters the corresponding one-handed operation mode according to the holding manner of the terminal by the user. Rather, in order to more quickly enter the corresponding one-handed operation mode, the following methods can also be used.

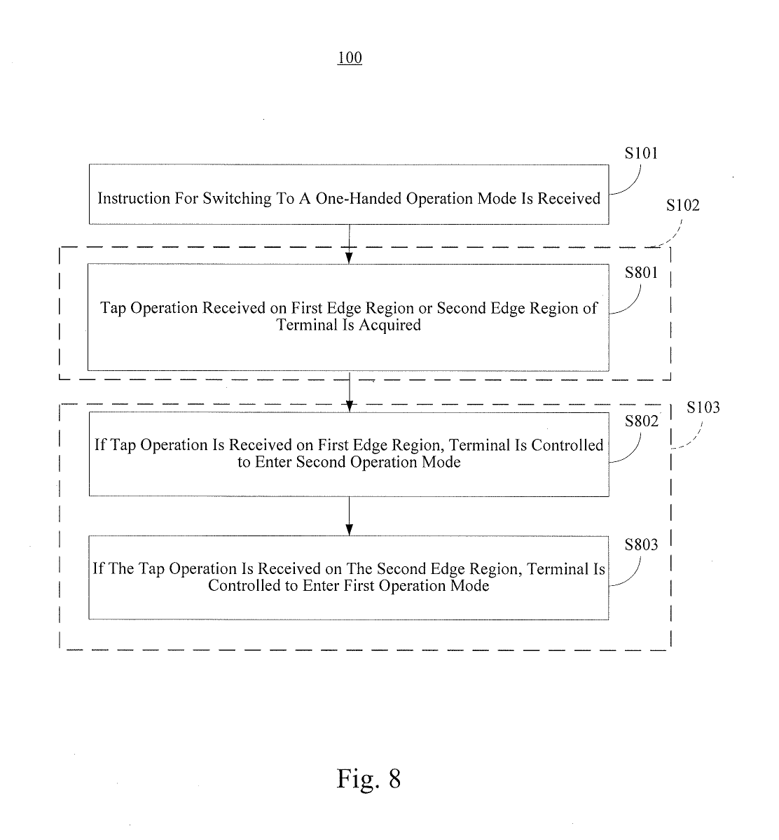

In one exemplary embodiment, shown in FIG. 8, step S102 (FIG. 1) further includes step S801. In step S801, a tap operation received on the first edge region or the second edge region of the terminal is acquired. The first edge region and the second edge region are on the touch edge of the terminal.

Accordingly, as shown in FIG. 8, step S103 (FIG. 1) further include steps S802-S803.

In step S802, if the tap operation is received on the first edge region, the terminal is controlled to enter the second operation mode.

In step S803, if the tap operation is received on the second edge region, the terminal is controlled to enter the first operation mode.

In the exemplary embodiment, the terminal may also enter the corresponding one-handed mode directly by receiving a tap operation on a touch edge region. For example, if the user wants to enter the left-handed operation mode (i.e., the second operation mode in the exemplary embodiment), the user may perform the tap operation on the left frame (i.e., the first edge region in the exemplary embodiment). After one tap, the left-handed operation mode may be entered; otherwise, if the user wants to enter the right-handed operation mode (i.e., the first operation mode in the exemplary embodiment), the user may perform the tap operation on the right frame (i.e., the second edge region in the exemplary embodiment). After one tap, the right-handed operation mode may be entered. In this way, user operation becomes easy, and the corresponding one-handed operation mode can be entered without cumbersome setting operations, and thus user experience is improved.

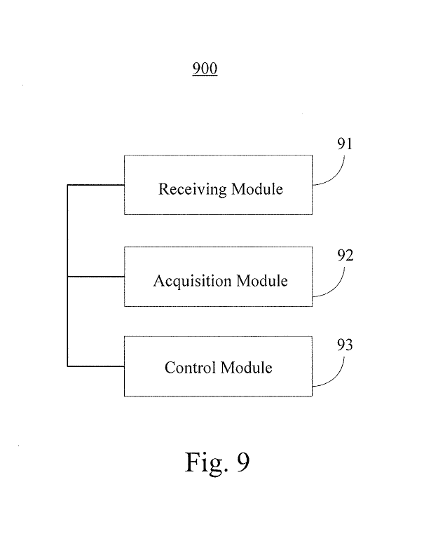

FIG. 9 is a block diagram of a device 900 for determining an operation mode of a terminal according to an exemplary embodiment. The device 900 may be realized by software, hardware, or a combination thereof, to be a part of the terminal or the whole terminal. As shown in FIG. 9, the device 900 includes a receiving module 91, an acquisition module 92, and a control module 93.

The receiving module 91 is configured to receive an instruction for switching to a one-handed operation mode.

The acquisition module 92 is configured to acquire touch information of a user on a touch edge of the terminal.

The control module 93 is configured to control the terminal to enter a corresponding one of one-handed operation modes according to the touch information. The one-handed operation modes include a first operation mode and a second operation mode.

In the exemplary embodiment, when the instruction for switching to the one-handed operation mode is received, the terminal acquires the touch information of the user on the touch edge of the terminal, and the terminal is controlled to enter the corresponding one-handed operation mode (such as a left-handed operation mode or a right-handed operation mode) according to the touch information. Thus, it is convenient for user operation, and user experience is improved.

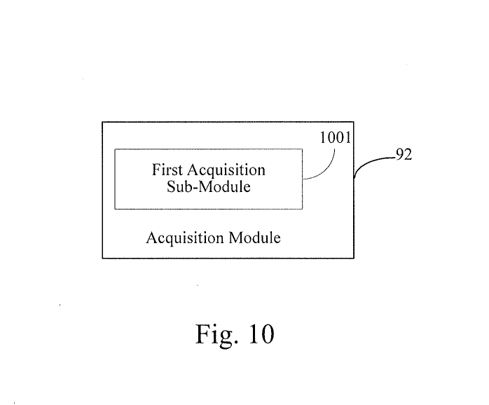

FIG. 10 is a block diagram of the acquisition module 92 (FIG. 9) according to an exemplary embodiment. As shown in FIG. 10, the acquisition module 92 includes a first acquisition sub-module 1001.

The first acquisition sub-module 1001 is configured to acquire one or more first touch points on a first edge region of the terminal and one or more second touch points on a second edge region of the terminal. The first edge region and the second edge region are on the touch edge of the terminal.

The touch edge of the terminal can be divided into the first and second edge regions, the first edge region can be the left edge region, and the second edge region can be the right edge region. When the user holds the terminal, the user's fingers will contact the first and second edge regions, and one or more touch points will be formed on the first and second edge regions.

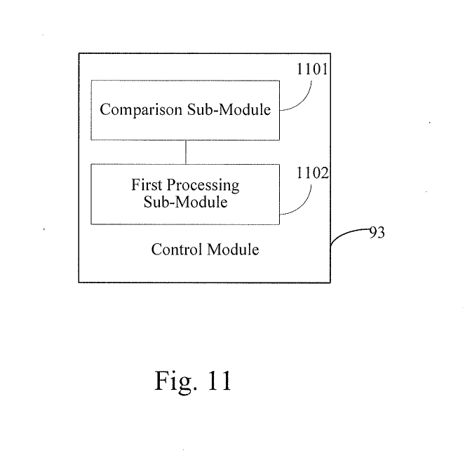

FIG. 11 is a block diagram of the control module 93 (FIG. 9) according to an exemplary embodiment. As shown in FIG. 11, the control module 93 includes a comparison sub-module 1101 and a first processing sub-module 1102.

The comparison sub-module 1101 is configured to compare a number of the one or more first touch points with a number of the one or more second touch points to obtain a comparison result.

The first processing sub-module 1102 is configured to control the terminal to enter the corresponding one of one-handed operation modes according to the comparison result.

In the exemplary embodiment, when the user uses different hands to hold the terminal, the number of the one or more first touch points on the first touch region and the number of the one or more second touch points on the second touch region are different. Therefore, by comparing the number of the one or more first touch points with the number of the one or more second touch points, the terminal can be controlled to enter the left-handed mode or the right-handed mode. Thus, it is convenient for the user to use the left hand or the right hand to perform the one-handed operation, and user experience is improved.

In one exemplary embodiment, the first processing sub-module 1102 is configured to, if the number of the one or more first touch points is greater than the number of the one or more second touch points, control the terminal to enter the first operation mode.

In one exemplary embodiment, the first processing sub-module 1102 is configured to, if the number of the one or more first touch points is fewer than the number of the one or more second touch points, control the terminal to enter the second operation mode.

In this way, the corresponding one-handed operation mode is entered according to a holding manner of the terminal by the user without manually setting the one-handed operation mode. Thus, user operation is reduced, and user experience is improved.

In one exemplary embodiment, the first processing sub-module 1102 is further configured to, if the number of the one or more first touch points is equal to the number of the one or more second touch points, compare a first area occupied by the one or more first touch points with a second area occupied by the one or more second touch points; if the first area is larger than the second area, control the terminal to enter the second operation mode; and if the first area is smaller than the second area, control the terminal to enter the first operation mode.

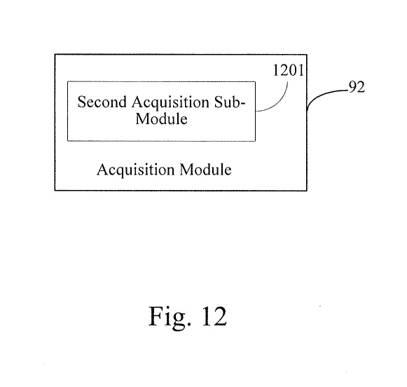

FIG. 12 is a block diagram of the acquisition module 92 (FIG. 9) according to an exemplary embodiment. As shown in FIG. 12, the acquisition module 92 includes a second acquisition sub-module 1201.

The second acquisition sub-module 1201 is configured to acquire a tap operation received on the first edge region or the second edge region of the terminal, wherein the first edge region and the second edge region are on the touch edge of the terminal.

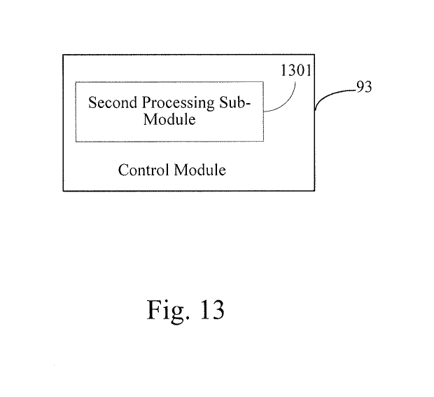

FIG. 13 is a block diagram of the control module 93 (FIG. 9) according to an exemplary embodiment. As shown in FIG. 13, the control module 93 includes a second processing sub-module 1301.

The second processing sub-module 1301 is configured to, if the tap operation is received on the first edge region, control the terminal to enter the second operation mode; and if the tap operation is received on the second edge region, control the terminal to enter the first operation mode.

In the exemplary embodiment, the terminal may also enter the corresponding one-handed mode directly by receiving a tap operation on a touch edge region. For example, if the user wants to enter the left-handed operation mode (i.e., the second operation mode in the exemplary embodiment), the user may perform the tap operation on the left frame (i.e., the first edge region in the exemplary embodiment) of the terminal. After one tap, the left-handed operation mode may be entered; otherwise, if the user wants to enter the right-handed operation mode (i.e., the first operation mode in the exemplary embodiment), the user may perform the tap operation on the right frame (i.e., the second edge region in the exemplary embodiment). After one tap, the right-handed operation mode may be entered. In this way, user operation becomes easy, and the corresponding one-handed operation mode can be entered without cumbersome setting operations, and thus user experience is improved.

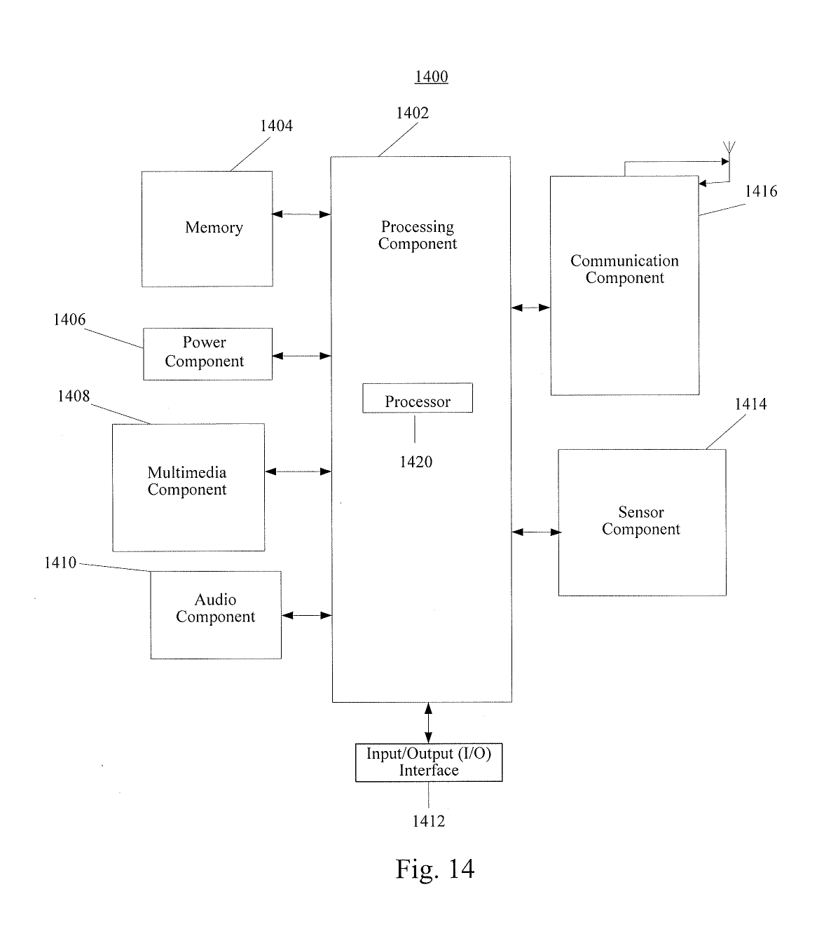

FIG. 14 is a block diagram of a device 1400 for determining an operation mode of a terminal according to an exemplary embodiment. The device 1400 may be a part of the terminal or the whole terminal, such as a mobile phone, a computer, a digital broadcast terminal, a messaging device, a gaming console, a tablet, a medical device, exercise equipment, a personal digital assistant, and the like.

The device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 may include a power management system, one or more power sources, and any other components associated with the generation, management, and distribution of power in the device 1400.

The multimedia component 1408 includes a screen providing an output interface between the device 1400 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1408 includes a front camera and/or a rear camera. The front camera and the rear camera may receive an external multimedia datum while the device 1400 is in an operation mode, such as a photographing mode or a video mode. Each of the front camera and the rear camera may be a fixed optical lens system or have focus and optical zoom capability.

The audio component 1410 is configured to output and/or input audio signals. For example, the audio component 1410 includes a microphone configured to receive an external audio signal when the device 1400 is in an operation mode, such as a call mode, a recording mode, and a voice recognition mode. The received audio signal may be further stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but are not limited to, a home button, a volume button, a starting button, and a locking button.

The sensor component 1414 includes one or more sensors to provide status assessments of various aspects of the device 1400. For instance, the sensor component 1414 may detect an open/closed status of the device 1400, relative positioning of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G, 3G, or 4G, or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404 and executable by the processor 1420 in the device 1400, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for determining an operation mode of a terminal, comprising:
receiving an instruction for switching to a one-handed operation mode;
acquiring touch information of a user on a touch edge of the terminal; and
controlling the terminal to enter a corresponding one of one-handed operation modes according to the touch information, wherein the one-handed operation modes include a first operation mode and a second operation mode.

2. The method of claim 1, wherein the acquiring the touch information of the user on the touch edge of the terminal comprises:
acquiring one or more first touch points on a first edge region of the terminal and one or more second touch points on a second edge region of the terminal, wherein the first edge region and the second edge region are on the touch edge of the terminal; and
the controlling the terminal to enter the corresponding one of one-handed operation modes according to the touch information comprises:
comparing a number of the one or more first touch points with a number of the one or more second touch points to obtain a comparison result; and
controlling the terminal to enter the corresponding one of one-handed operation modes according to the comparison result.

3. The method of claim 2, wherein the controlling the terminal to enter the corresponding one of one-handed operation modes according to the comparison result comprises:
if the number of the one or more first touch points is greater than the number of the one or more second touch points, controlling the terminal to enter the first operation mode; and
if the number of the one or more first touch points is fewer than the number of the one or more second touch points, controlling the terminal to enter the second operation mode.

4. The method of claim 2, wherein the controlling the terminal to enter the corresponding one of one-handed operation modes according to the comparison result comprises:
if the number of the one or more first touch points is equal to the number of the one or more second touch points, comparing a first area occupied by the one or more first touch points with a second area occupied by the one or more second touch points;
if the first area is larger than the second area, controlling the terminal to enter the second operation mode; and
if the first area is smaller than the second area, controlling the terminal to enter the first operation mode.

5. The method of claim 1, wherein the acquiring the touch information of the user on the touch edge of the terminal comprises:
acquiring a tap operation received on one of the first edge region or the second edge region of the terminal, wherein the first edge region and the second edge region are on the touch edge of the terminal; and
the controlling the terminal to enter the corresponding one of one-handed operation modes according to the touch information comprises:
if the tap operation is received on the first edge region, controlling the terminal to enter the second operation mode; and
if the tap operation is received on the second edge region, controlling the terminal to enter the first operation mode.

6. The method of claim 1, wherein the first operation mode is a right-handed operation mode, and the second operation mode is a left-handed operation mode.

7. A terminal, comprising:
a processor; and
a memory for storing instructions executable by the processor;
wherein the processor is configured to:
receive an instruction for switching to a one-handed operation mode;
acquire touch information of a user on a touch edge of the terminal; and
control the terminal to enter a corresponding one of one-handed operation modes according to the touch information, wherein the one-handed operation modes include a first operation mode and a second operation mode.

8. The terminal of claim 7, wherein the processor is further configured to:
acquire one or more first touch points on a first edge region of the terminal and one or more second touch points on a second edge region of the terminal, wherein the first edge region and the second edge region are on the touch edge of the terminal;
compare a number of the one or more first touch points with a number of the one or more second touch points to obtain a comparison result; and
control the terminal to enter the corresponding one of one-handed operation modes according to the comparison result.

9. The terminal of claim 8, wherein the processor is further configured to:
if the number of the one or more first touch points is greater than the number of the one or more second touch points, control the terminal to enter the first operation mode; and
if the number of the one or more first touch points is fewer than the number of the one or more second touch points, control the terminal to enter the second operation mode.

10. The terminal of claim 8, wherein the processor is further configured to:
if the number of the one or more first touch points is equal to the number of the one or more second touch points, compare a first area occupied by the one or more first touch points with a second area occupied by the one or more second touch points;
if the first area is larger than the second area, control the terminal to enter the second operation mode; and
if the first area is smaller than the second area, control the terminal to enter the first operation mode.

11. The terminal of claim 7, wherein the processor is further configured to:
acquire a tap operation received on one of the first edge region or the second edge region of the terminal, wherein the first edge region and the second edge region are on the touch edge of the terminal; and
if the tap operation is received on the first edge region, control the terminal to enter the second operation mode; and
if the tap operation is received on the second edge region, control the terminal to enter the first operation mode.

12. The terminal of claim 7, wherein the first operation mode is a right-handed operation mode, and the second operation mode is a left-handed operation mode.

13. A non-transitory readable storage medium having stored therein instructions that, when executed by a processor of a terminal, cause the terminal to perform a method for determining an operation mode of the terminal, the method comprising:
receiving an instruction for switching to a one-handed operation mode;
acquiring touch information of a user on a touch edge of the terminal; and
controlling the terminal to enter a corresponding one of one-handed operation modes according to the touch information, wherein the one-handed operation modes include a first operation mode and a second operation mode.
